(19) United States
(12) Patent Application Publication
(10) Pub. No.: US 2013/0183461 A1
(43) Pub. Date: Jul. 18, 2013

(54) CRAFT FLOWER AND METHOD OF MAKING A CRAFT FLOWER

(71) Applicant: Julie Comstock, Nibley, UT (US)

(72) Inventor: Julie Comstock, Nibley, UT (US)

(21) Appl. No.: 13/350,683

(22) Filed: Jan. 13, 2012

(51) Int. Cl. A41G 1/00; A41G 1/02; B32B 37/12

(52) U.S. Cl. 428/26; 156/61; 428/24

(57) ABSTRACT

A method of making a craft flower can include the following steps: (i) Providing an adhesive member. This adhesive member can be substantially flat and be kept between two pieces (e.g., sheets) of carrier material. (ii) Removing a top piece of carrier material to expose a top side of the adhesive member. (iii) Providing a strip of material (e.g., fabric, ribbon, paper, plastic, tulle, foil, mylar, film material, etc.) that is sufficiently manipulable so as to be capable of being gathered together. (iv) Wrapping the strip of material around at least the outer portion of the top side of the adhesive member in a desired design and pressing the strip of material onto the adhesive member. Various examples of desired designs are described and illustrated herein.

### BACKGROUND

The present invention relates to decorations, particularly to craft flowers. Natural flowers are universally admired and used to beautify the environment, including homes, businesses, yards, and parks. Artificial and craft flower are made to imitate the beauty and of natural flowers. Some artificial and craft flowers are made as nearly identical replicas of natural flowers, while others are created as non-identical representations. As opposed to natural flowers, artificial and craft flowers can be made of a variety of materials and can last almost indefinitely.

### SUMMARY

The present invention has been developed to provide a craft flower and method of making a craft flower that can be applied to clothing, fashion accessories, gift cards and boxes, or other suitable surfaces. The method can be performed by craftspeople of various skill levels, quickly to provide a pleasing decoration that can be adhered to almost any object.

In one aspect of the invention, the method of making a craft flower includes the following steps: (i) Providing an adhesive member which can be substantially flat and be kept between two removable pieces (e.g., sheets) of carrier material; (ii) Removing a top piece of carrier material to expose a top side of the adhesive member; (iii) Providing a strip of material (e.g., fabric, ribbon, paper, plastic, tulle, foil, mylar, film material, etc.) that is sufficiently flexible to be gathered together; and (iv) Wrapping the strip of material around at least a portion of the top side of the adhesive member in a selected pattern and pressing the strip of material onto the adhesive member. Various examples of selected or predetermined patterns are described and illustrated herein.

In another aspect of the invention, a craft flower includes an adhesive member and a strip of material. The adhesive member is substantially flat and has two opposing sides each with adhesive properties. The strip of material is sufficiently flexible to be gathered together. The strip of material is wrapped around and coupled to at least a portion of one side of the adhesive member in substantially a selected or predetermined pattern.

In yet another aspect of the invention, a craft flower kit includes one or more adhesive members kept between two removable carrier members and one or more strips of material that is sufficiently flexible to be gathered together. The one or more adhesive members each have a substantially circular shape with a diameter between about 1 inch to about 6 inches. Each adhesive member is substantially flat. The two carrier members are disposed on opposite sides of the adhesive member. In some instances, the kit includes adhesive members of difference sizes, and may include one or more other ornaments, such as gems, buttons, beads, or other decorative components.

These and other features and advantages of the present invention may be incorporated into certain embodiments of the invention and will become more fully apparent from the following description and appended claims, or may be learned by the practice of the invention as set forth hereinafter. The present invention does not require that all the advantageous features and all the advantages described herein be incorporated into every embodiment of the invention.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. These drawings depict only typical embodiments of the invention and are not therefore to be considered to limit the scope of the invention.

FIG. 1 is a perspective view of a kit for making a craft flower and a resulting craft flower, according to some embodiments.

FIG. 2 is a perspective view of the process of removing a carrier material from a first side of an adhesive member, according to some embodiments.

FIG. 3 is a perspective view of adhesive member after the carrier material is removed from its first side, according to some embodiments.

FIG. 4 is a perspective view of a strip of material, according to some embodiments.

FIG. 5 is a perspective view of a knot in an end of the strip of material, according to some embodiments.

FIG. 6 is a perspective view of a process of pressing the knot onto the exposed first side of the adhesive material, according to some embodiments.

FIG. 7 is a perspective view of a process of wrapping the coiled material around the knot and pressing it onto the adhesive material in a selected or predetermined pattern, according to some embodiments.

FIG. 8 is a perspective view of a process of cutting the decorative material, according to some embodiments.

FIG. 9 is a perspective view of a process of attaching an end of the decorative material to a second side of the adhesive material, according to some embodiments.

FIG. 10 is a perspective view of an illustrative coiled flower, according to some embodiments.

FIG. 11 is a perspective view of an initial stage of a process of wrapping a substantially flat decorative material around a portion of the adhesive material in a selected or predetermined pattern, according to some embodiments.

FIG. 12 is a perspective view of a later stage of a process of wrapping a substantially flat decorative material around a portion of the adhesive material in a selected or predetermined pattern, according to some embodiments.

FIG. 13 is a perspective view of the craft flower with a strip of substantially flat material as made by the process shown in FIGS. 11 to 12, according to some embodiments.

FIG. 14 is a perspective view of the process of adding an ornament to the craft flower of FIG. 13, according to some embodiments.

FIG. 15 is a perspective view of five completed craft flowers, according to some embodiments.

FIG. 16 is a perspective view of an initial stage of a process of wrapping a substantially flat decorative material around a portion of the adhesive material in a selected or predetermined pattern, according to some embodiments.

FIG. 17 is a perspective view of a later stage of a process of wrapping a substantially flat decorative material around a portion of the adhesive material in the selected or predetermined pattern begun in FIG. 16, according to some embodiments.

FIG. 18 is a perspective view of yet a later stage of a process of wrapping a substantially flat decorative material around a portion of the adhesive material in the selected or predetermined pattern begun in FIG. 16, according to some embodiments.

FIG. 19 is a perspective view of the craft flower made with a strip of substantially flat material as made by the process shown in FIGS. 16 to 18, according to some embodiments.

### DETAILED DESCRIPTION OF THE INVENTION

The presently preferred embodiments of the present invention can be understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

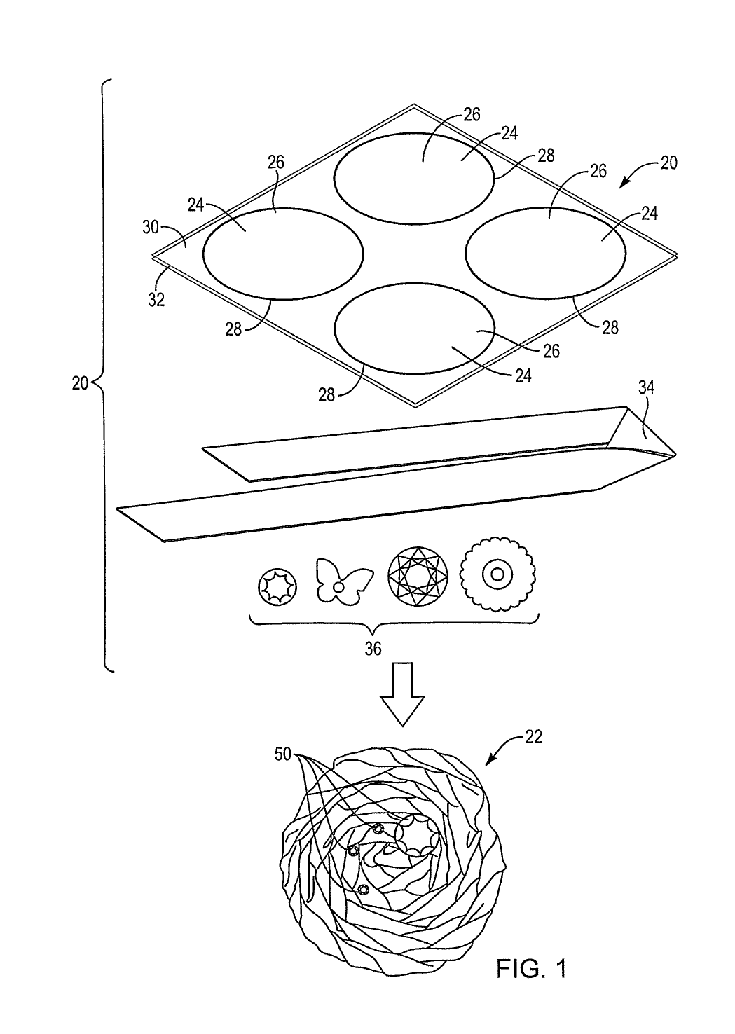

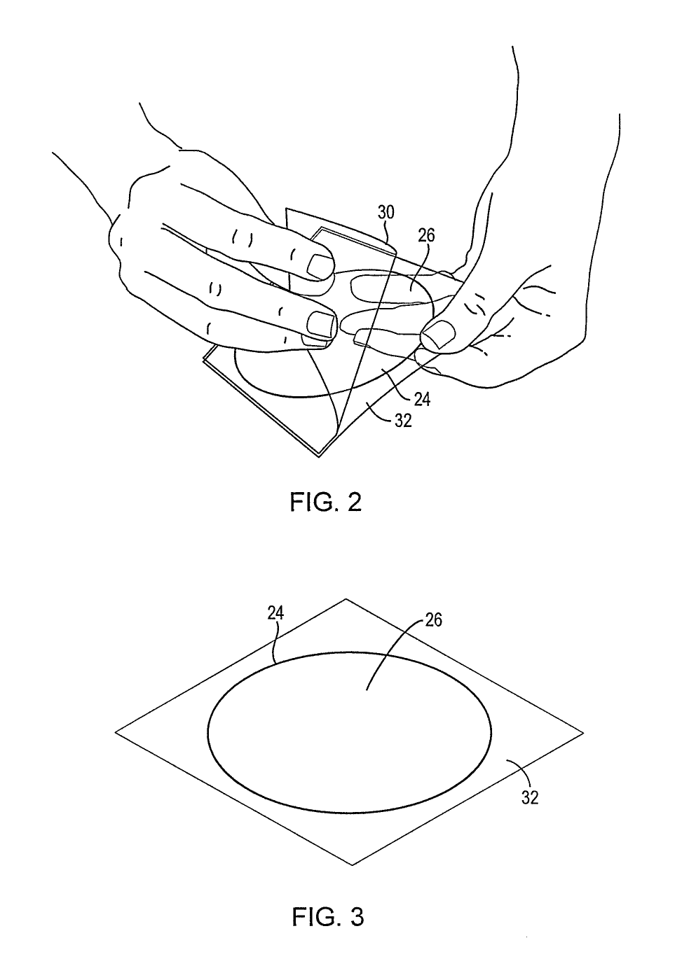

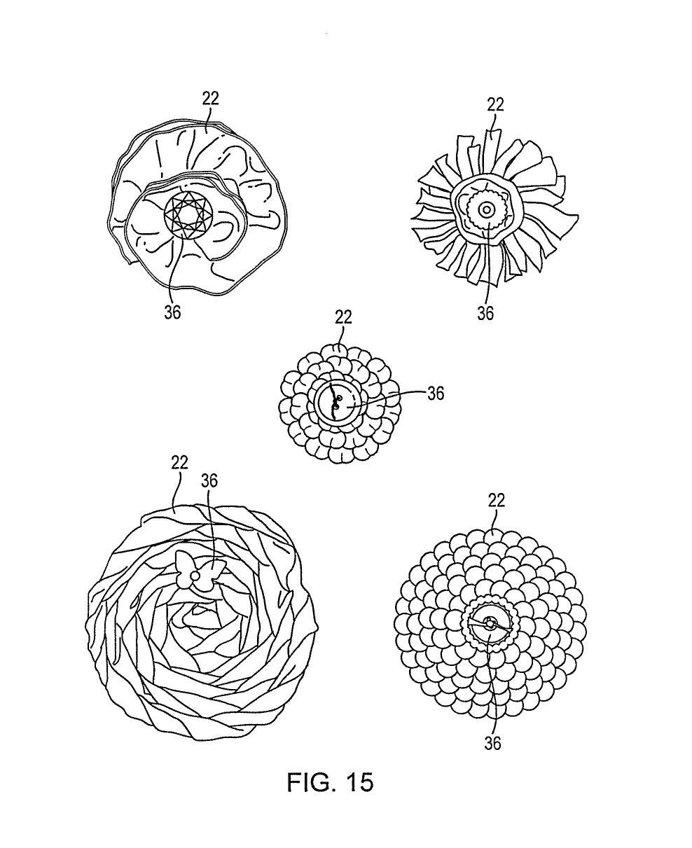

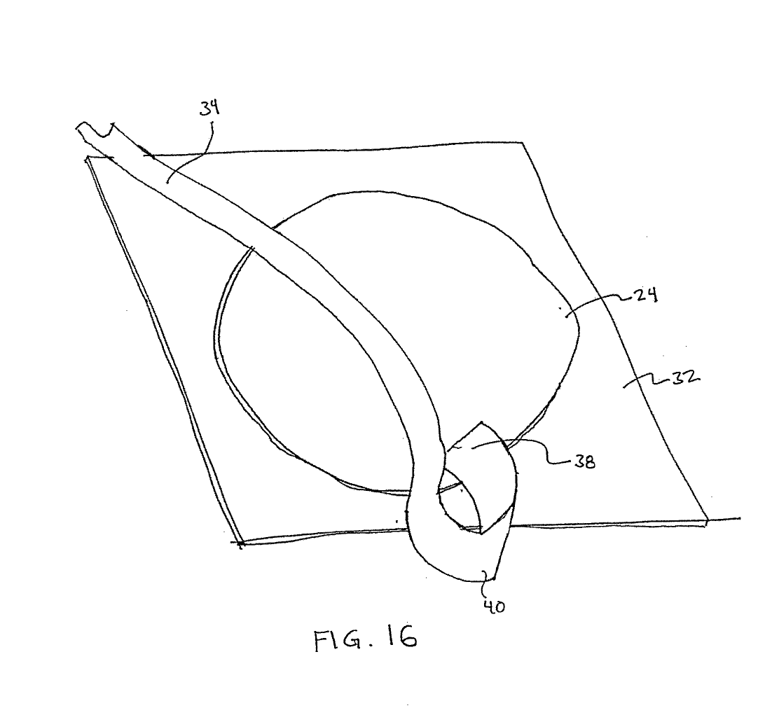

The figures show some embodiments of craft flowers and methods of making craft flowers. FIG. 1 illustrates a set of materials, which may be included within a kit, that can be used to form the illustrated craft flower. Representative steps for making the craft flower are illustrated in FIGS. 2 through 10. FIGS. 11 through 14 illustrate steps for making another type of craft flower. FIG. 15 is then provided to illustrate various types of craft flowers that can be made using the kit of FIG. 1 and the present methods, as described and claimed herein.

Referring specifically to FIG. 1, in some embodiments of the invention, a kit 20 is provided for making one or more craft flowers, as shown. The kit can include the components used in preparing one or more craft flowers 22. For example, in the illustrated embodiment, the kit includes a set of one or more adhesive members 24, a decorative material 34 (e.g., a strip of decorative material), and a set of ornaments 36. Each of these components will now be discussed. In some instances, the kit includes adhesive members of difference sizes.

As shown in FIG. 1, in some embodiments, an adhesive member 24 is used to make a craft flower 22. The adhesive member 24 can be a generally two-sided, substantially flat piece of adhesive material. The two sides can be separated by a thickness, including between about 0.5 millimeters to about 1.0 millimeters, 1.0 millimeters to about 1.5 millimeters, about 1.5 millimeters to about 3.0 millimeters, about 3.0 millimeters to about 5.0 millimeters, or over about 5.0 millimeters. Various adhesive materials can be used to provide varying degrees of adhesive properties or tackiness. Accordingly, the bond between the adhesive member and the strip of material can be temporary or permanent. Non-limiting examples of adhesive materials that can be used to form the adhesive member include adhesive members available from MBM Enterprises Ltd. of the Fengxian District, Shanghai 201401 China.

The adhesive member 24 can have various shapes and sizes depending on the desired shape and size of the final craft flower 22. For example, the adhesive member can be in the shape of a circle, a square, a rectangle, a star, or in the shape of another polygon. In some instances, the adhesive member can be in the shape of a type of flower. Circular-shaped adhesive members 24 can have a diameter of about ½ inches, about ¾ inches, about 1 inch, about 1¼ inches, about 1½ inches, about 1¾ inches, about 2 inches, about 2¼ inches, about 2½ inches, about 2¾ inches, about 3 inches, about 3¼ inches, about 3½ inches, about 3¾ inches, about 4 inches, about 4¼ inches, about 4½ inches, about 4¾ inches, about 5 inches, about 5¼ inches, about 5½ inches, about 5¾ inches, about 6 inches, or more than about 6 inches. Other shaped adhesive members can have various sizes, including between about 0.2 square inches to about 1.0 square inch, about 1.0 square inches to about 5 square inches, about 5 square inches to about 10 square inches, about 10 square inches to about 20 square inches, about 20 square inches to about 50 square inches, or greater than about 50 square inches.

The adhesive member 24 can be placed between two carrier members 30, 32. The carrier members can be sheets, including transparent sheets, that can be selectively removed from the adhesive member without ripping, deforming, or adhering to the adhesive member. Non-limiting examples of carrier members 30 and 32 include wax paper, flexible plastic, and other suitable materials.

Reference will now be made to the decorative material 34. Non-limiting examples of decorative materials includes fabric, ribbon, paper, plastic, tulle, foil, mylar, film material, ropes, yarn, threads, and other suitable materials. Decorative material can be used by sticking it to the adhesive member 24 in a predetermined pattern. Various such patterns are described herein. For example, material 34 can be wrapped in a spiral pattern around the center of the adhesive member beginning near the center and working outwardly to the outside of the adhesive member, resulting in the craft flower 22 shown in FIG. 1. The type, texture, thickness, and color of material used will create the overall impression of the resulting craft flower. Accordingly, various types of materials can be used, having various textures, thicknesses, and colors.

Additionally, the dimensions of the material 34 can affect the resulting appearance and impression of the craft flower. When made using a spiral pattern, as with the craft flower of FIG. 1, the dimensions of the strip of material can determine the number of coils or winds in the resulting spiral pattern. Thus, the dimensions of the material may be a matter of design choice and/or preference. Representative widths of the material 34 can include about ⅛ inches, about ¼ inches, about ⅜ inches, about ½ inches, about ¾ inches, about 1 inch, about 1¼ inches, about 1½ inches, about 1¾ inches, about 2 inches, about 2½ inches, about 3 inches, about 3½ inches, about 4 inches, and about greater than 4 inches. The length of the material may be cut to size. Accordingly, in some instances, a long strip of material may be used to make many craft flowers. In other instances, a strip of material is provided pre-cut. Non-limiting lengths of a strip of material can include 2 inches, about 4 inches, about 6 inches, about 8 inches, about 12 inches, about 1½ feet, about 2 feet, about 3 feet, about 4 feet, about 6 feet, about 10 feet, and about greater than 10 feet depending upon the nature of the material 34.

In some embodiments, two or more different materials may be used to make the craft flower 22. For examples, a first strip of material can be applied to form a first layer of material (e.g., about one portion of the adhesive member), then a second strip of material can be applied to form a second layer of material about another portion of the adhesive member. This process can even be repeated using additional strips of material. In some instances, the multiple strips of material are of the same type of material to provide a uniform appearance. In other instances, the multiple strips of material are of different types, textures, colors, and/or thicknesses. Using other patterns, multiple strips of materials can be applied simultaneously and/or twisted together.

Reference will now be made to the set of ornaments 36. Just as natural flowers have various structures and are not simply petals, the craft flower can also include structures besides just the strip of material. For example, an ornament can be placed in the center of the craft flower. Various types of ornaments can be used. Non-limiting examples of ornaments include buttons, beads, jewels (real or artificial), fake bugs or butterflies, and other such ornaments.

Reference will now be made to methods of making a craft flower 22. Generally, a craft flower is made using an adhesive member and a material 34. The material 34 can be sufficiently flexible to be gathered together. As shown in FIG. 2, initially a first piece of carrier material 30 is removed from a first side 26 of the adhesive member 24, exposing the first side, as shown in FIG. 3. The second piece of carrier material 32 can remain in place to facilitate handling of the adhesive member 24. Material 34 is pressed onto the adhesive member in substantially a desired design. Because the flower is a craft flower, the desired design does not have to be rigidly followed or require machine-type dexterity, but can accommodate the occasional unsteady hand and inexperienced craftsperson. Pressing the material 34 onto the adhesive member can secure it onto the exposed adhesive surface.

As mentioned, various predetermined patterns can be used with the general method described to provide an assortment of craft flowers 22. Two such examples will now be described. It will be understood that other patterns can be used to make craft flowers. For example, a pattern can include forming multiple loops from the strip of material, the end of each loop being pressed onto the adhesive member. This pattern of loops can be wrapped around the adhesive member one or more times. FIG. 15 illustrates various embodiments of craft flowers made using different patterns.

### EXAMPLE 1

### A Craft Flower having a Spiral Pattern

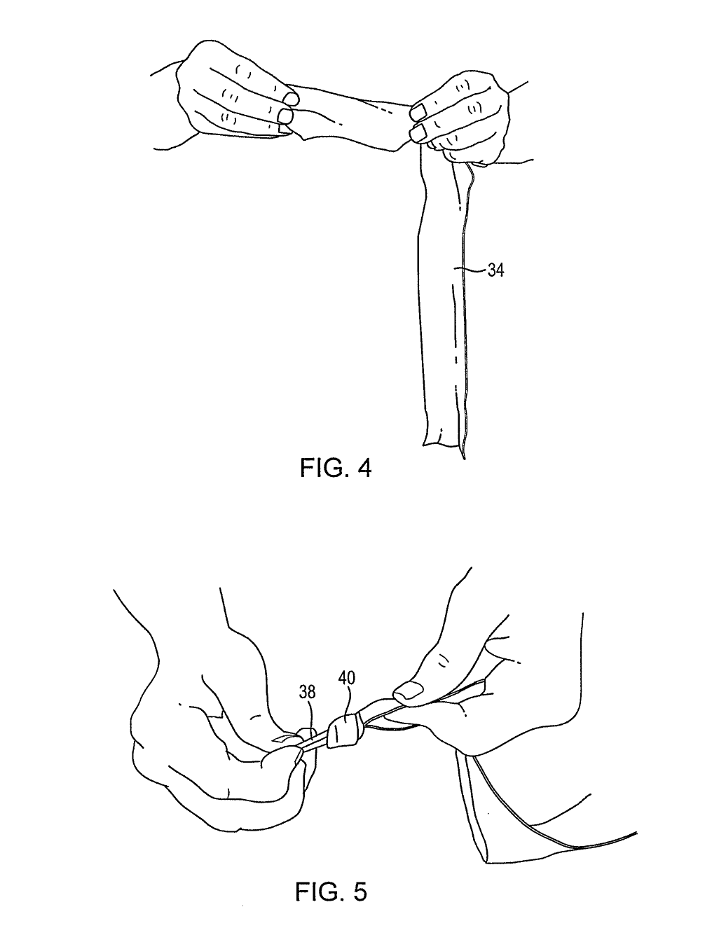

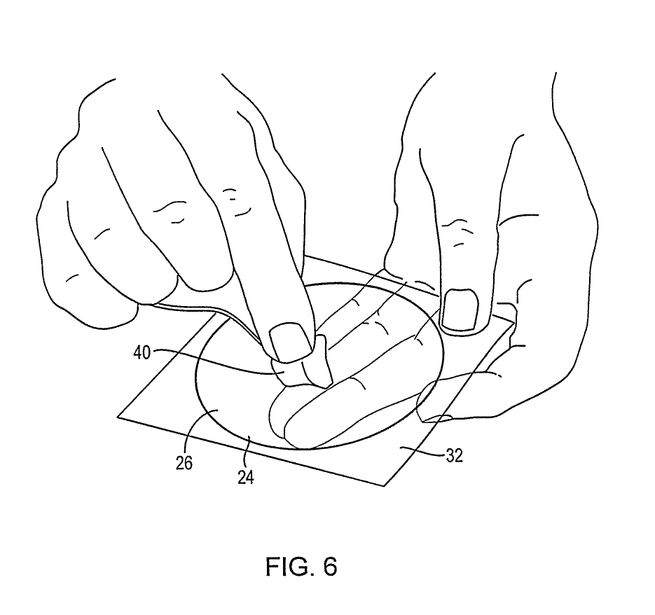

Reference will now be made to FIGS. 4 through 10, which illustrates a method of making a craft flower 22 using a spiral pattern. In FIG. 4, a strip of material 34 approximately 2 inch by 4 feet fabric is provided. In FIG. 5, a knot 40 is formed on a first end 38 of the strip of material. In some instances, excess material can be cut away from the first end leaving the knot. In FIG. 6, the knot is placed on the exposed top surface 26 of the adhesive member 24. The adhesive member 24 can be a 3-inch circle. In some instances, the knot is placed and pressed into approximately the center of the adhesive member 24 or within a central portion of thereof. As used herein the central portion of an adhesive member 24 can include the area immediately about the exact center. This can also be referred to as the inner portion, and may include approximately 20 percent to approximately 50 percent of the entire area of the adhesive member. Outside of the central or inner portion are the outer portion, which include the edges of the adhesive member 24.

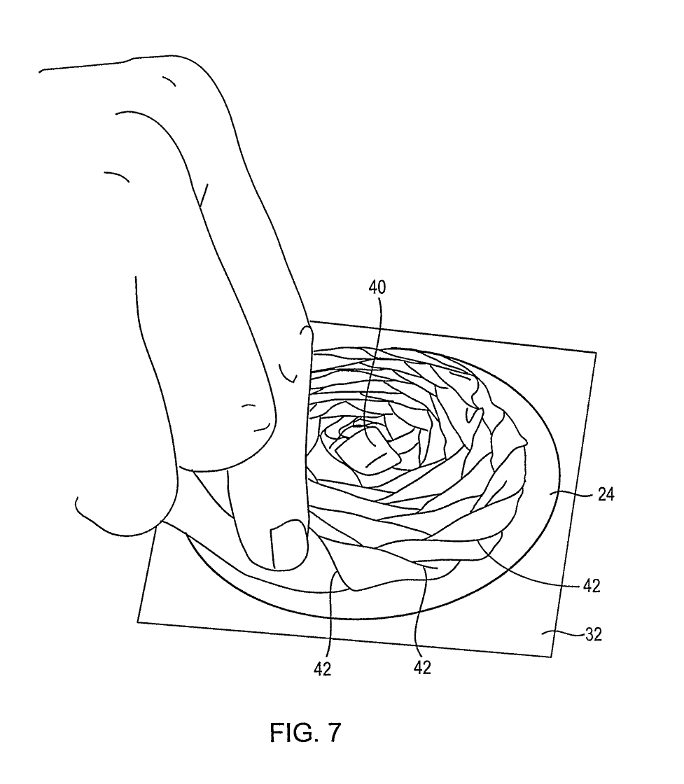

As shown in FIG. 7, after the knot 40 is secured to the adhesive member 24, the portions of the strip of flexible material 34 extending away from the knot can be manipulated around the knot in a desired design, such as a spiral pattern, extending from the inner portion of the adhesive member to the outer portion of the adhesive member 24. As shown, in some embodiments, the strip of material is manipulated (e.g., coiled or twisted) periodically as it is wrapped around the knot. Representative twists are indicated with the numeral 42. In addition to wrapping the strip of material, the craftsperson can press the strip of material 34 into the adhesive member 26. This pressure can ensure that the strip of material contacts the adhesive member and is secured thereto.

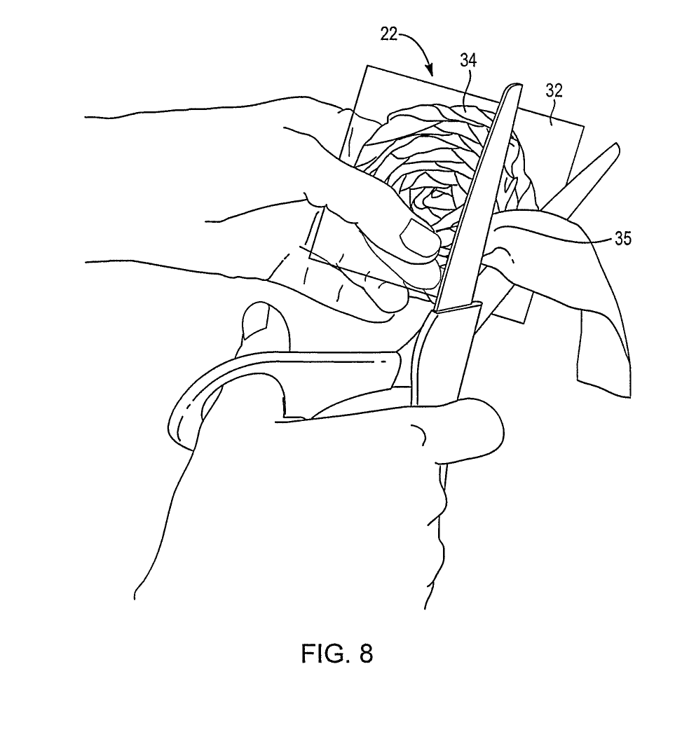

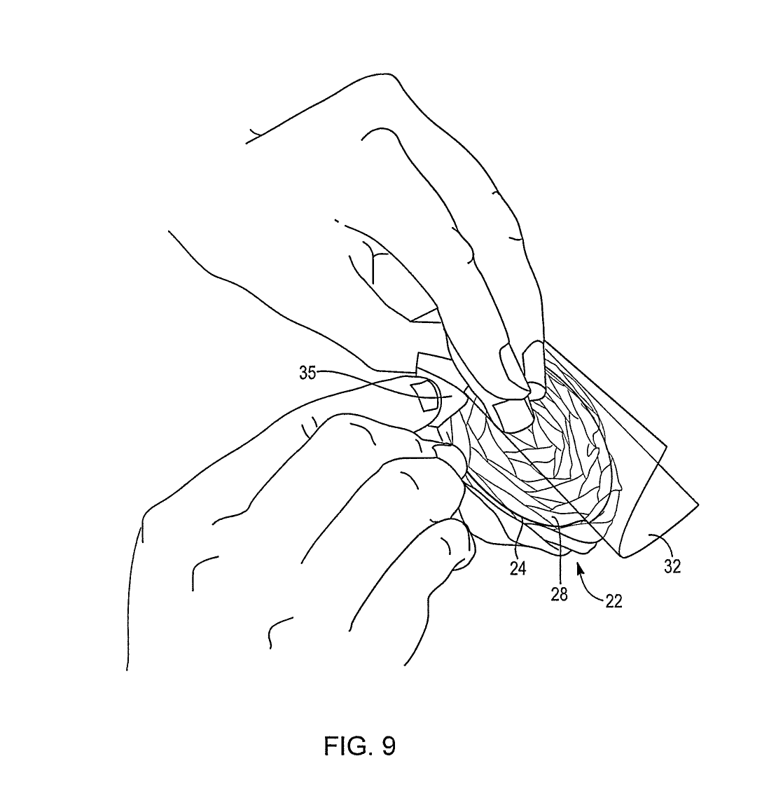

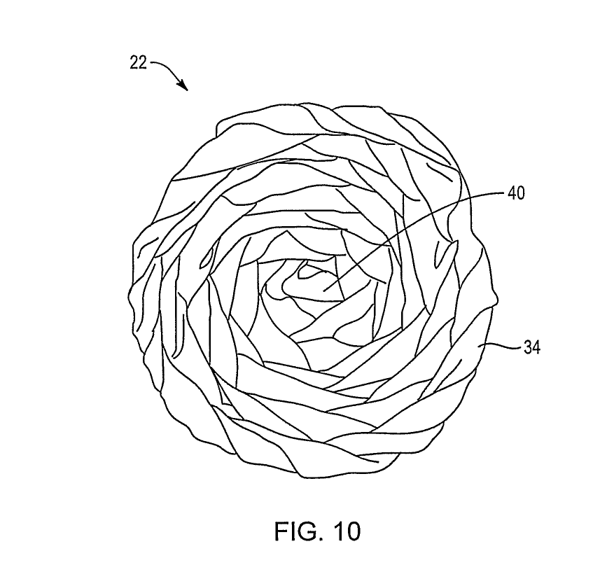

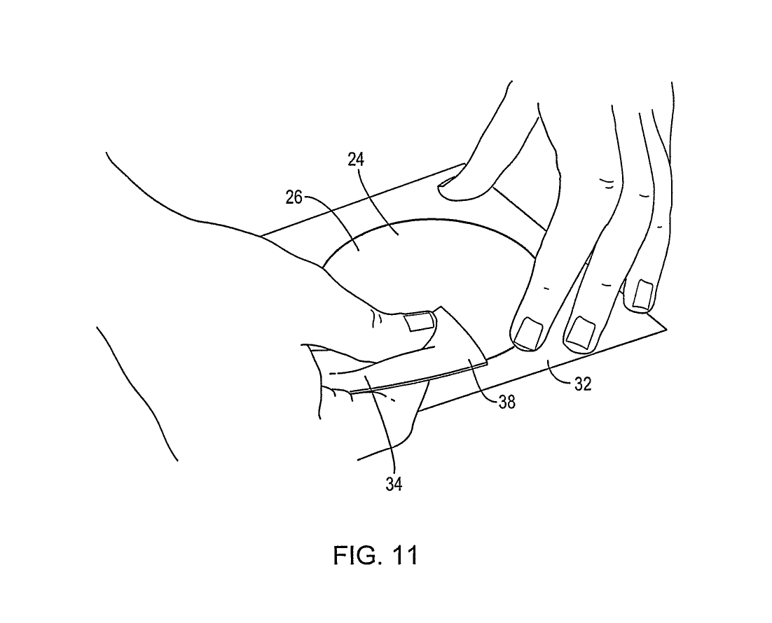

As shown in FIG. 8, the strip of material 34 can be wrapped in a spiral pattern and pressed into the adhesive member 24 until it reaches the outer edge. When it is no longer possible to secure the strip of material to the exposed top surface of the adhesive member 24, the remaining length of the strip of material can be cut off. As shown in FIG. 9, in some instances, a portion 35 of the strip of material can be folded under the adhesive member and pressed onto the bottom surface of the adhesive member to prevent the strip of material from unraveling or fraying.

Thus prepared, as shown in FIG. 10, the second piece of carrier material 32 can be removed and the exposed bottom surface 28 of the adhesive member 24 can applied to an object, such as a gift package, clothing, a gift card, or another suitable object. In other instances, the second piece of carrier material 32 can remain temporarily or permanently. As shown in FIG. 1, one or more ornaments 36 can be applied to the craft flower, including beads, jewels (real or artificial) as shown.

### EXAMPLE 2

### A Craft Flower having another Spiral Pattern

Reference will now be made to FIGS. 11 through 14, which illustrates another illustrative method of making a craft flower 22 using a spiral wrap pattern. As shown in FIG. 11, the strip of material 34 can be a strip of 1-inch fabric and the adhesive member 24 can be a 2-inch circle. In this pattern, no knot is formed in the end of the strip of material 34. As illustrated, a first end 38 of strip of flexible material 34 can be manipulated and pressed to an outer portion of the adhesive member near the outer edge thereof. The material 34 can extend outwardly over the edge of the adhesive member 24 such that an inner side (closest to the center of the adhesive member 24) of the strip of material is applied to the adhesive member 24 while an outer side of the strip of material extends over the edge of the adhesive member.

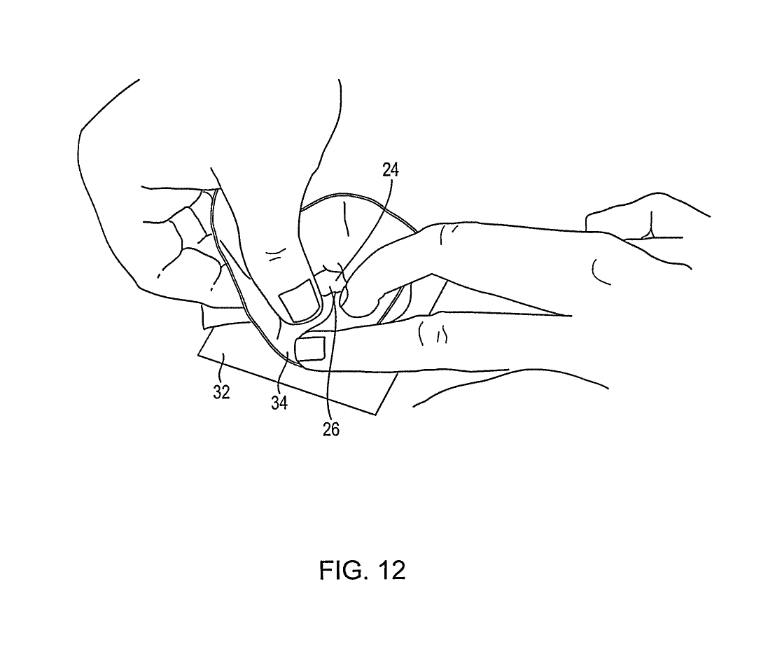

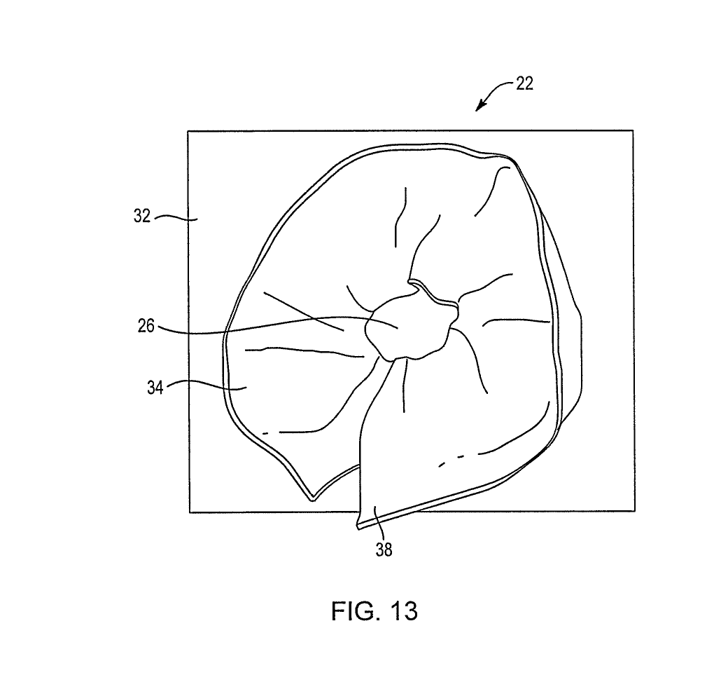

As illustrated in FIG. 12, as the strip of material 34 is wrapped around the outer portion of the adhesive member 24, the inner side of the strip of material is overlapped or bunched together. The overlapped or bunched inner side is then pressed onto the adhesive member 24. Once the strip of material is wrapped completely around the outer portion of the adhesive member 24 the extra length of the strip of material can be cut. In some embodiments, the two ends of the strip of material can be glued together to make the strip of material appear continuous. In other embodiments, these two ends are not glued together, as shown in FIG. 13.

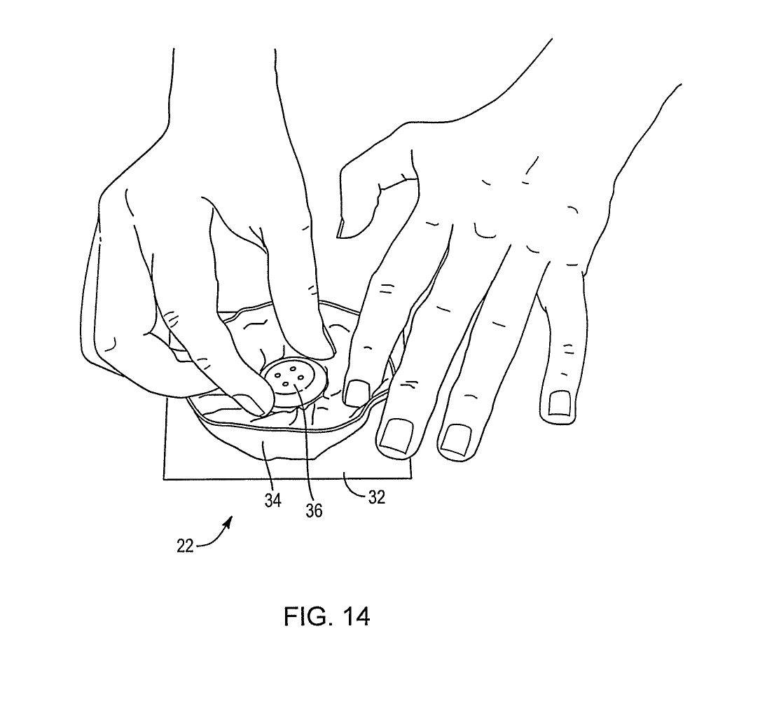

As shown in FIG. 14, in some instances, one or more ornaments can be placed in the middle of the craft flower 22. In other instances, another strip of material can be wrapped around the inside of the adhesive member 24 to form a layer of material. Additionally, multiple such layers can be created, where space is available on the adhesive member. The number of potential layers will be depended upon the shape and size of the adhesive member and the strip of material.

### EXAMPLE 3

### A Craft Flower having a Loop Pattern

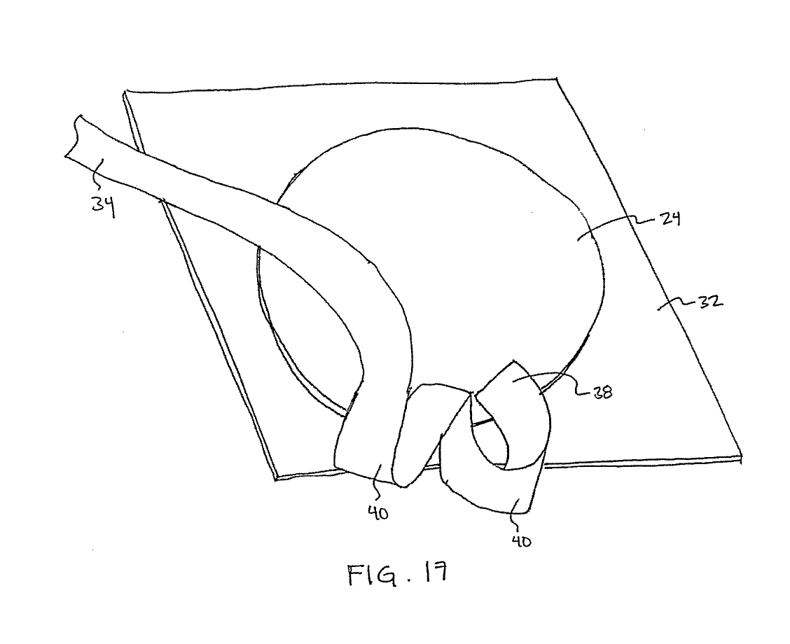

Reference will now be made to FIGS. 16 through 19, which illustrates another illustrative method of making a craft flower 22 using a loop pattern. As shown in FIG. 16, the strip of material 34 can be a strip of ribbon, as shown, and the adhesive member 24 can be a 2-inch circle. In this pattern, no knot is formed in the end of the strip of material 34. As illustrated, a first end 38 of strip of flexible material 34 can be manipulated and pressed to an outer portion of the adhesive member 24 near the outer edge thereof. The strip of material 34 can be directed outwardly over the edge of the adhesive member 24 and then manipulated so that is loop back towards the adhesive member 24 to form a loop 40 that is pressed into the adhesive member 24.

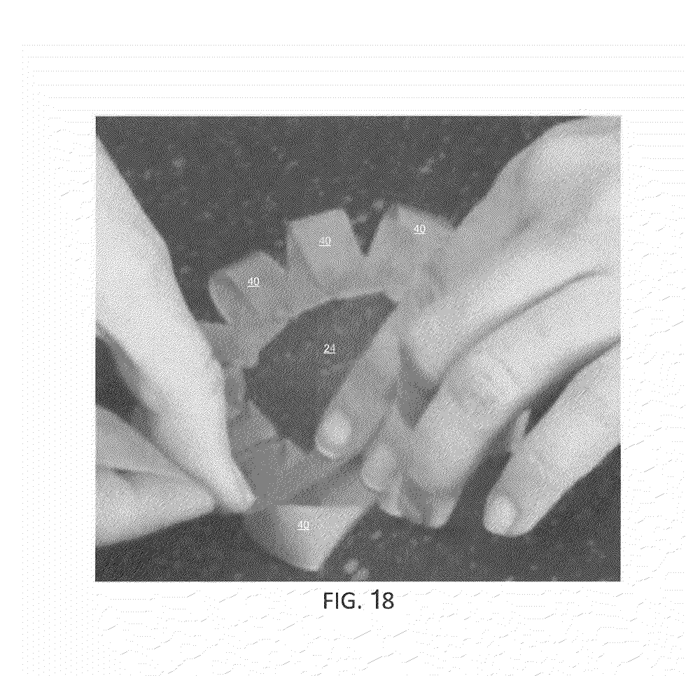

As illustrated in FIG. 17, after making a first loop 40 around the outer portion of the adhesive member 24, the strip of material 34 can be manipulated so that it folds back toward the outer edge of the adhesive member 24 and a second, subsequent loop 40 can be formed of the strip of material 34. In some instance, these adjacent loops 40 can at least partially overlap. This pattern of forming consecutive loops 40 around the outer portion of the adhesive member 24 can continue until loops 40 are formed around the entire outer portion of the adhesive member 24, as shown in FIG. 18.

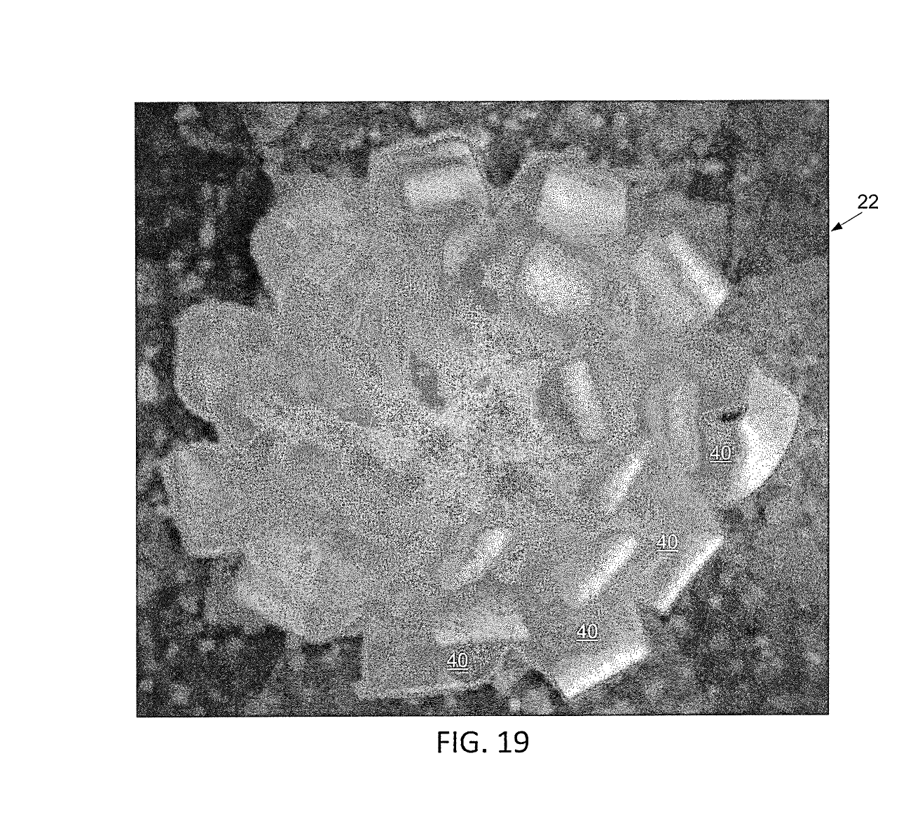

In some instances, this loop pattern is continued around the remaining exposed portions of the adhesive member 24 to form a spiral of loops 40 until the center of the adhesive member 24 is reached, as shown in FIG. 19. The number of potential circles of loops 40 will be depended upon the shape and size of the adhesive member 24 and the strip of material 34. Additionally, in some instances, one or more ornaments 36 can be placed on the craft flower 22, including, but not limited to an ornament 36 in the middle of the craft flower 22.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A method of making a craft flower, comprising:
providing an adhesive member disposed between a first piece of carrier material and a second of carrier material, the adhesive member being substantially flat;
removing the first piece of carrier material to expose a first side of the adhesive member;
providing a strip of material which can be manipulated to a desired design;
manipulating the strip of material to the desired design; and
pressing at least a portion of the manipulated strip of material onto the first side of the adhesive member.

2. The method of claim 1, further comprising:
removing the second pieces of carrier material to exposed the second side of the adhesive member; and
applying the second side of the adhesive member to an object.

3. The method of claim 1, wherein the trip of material comprises an inner side and an outer side and wherein the method further comprises pressing only an inner side of the strip of material onto the adhesive member.

4. The method of claim 1, wherein the desired design comprises a spiral pattern that extends from an inner portion of the adhesive member to an outer portion of the adhesive member.

5. The method of claim 4, further comprising forming a knot in a first end of the strip of material and pressing the knot onto the center of adhesive member.

6. The method of claim 5, wherein the predetermined pattern includes a single wrap around the outer portion of the adhesive member, wherein an outer side of the strip of material extends outwardly from the outer portion of the adhesive member.

7. The method of claim 1, wherein the desired design comprises a spiral pattern that extends from the outer portion of the adhesive member to an inner portion of the adhesive member.

8. The method of claim 1, further comprising:
providing a second strip of material sufficiently manipulable so as to be capable of being gathered together;
wrapping the second strip of material around and pressing the second strip of material onto at least an exposed portion of the first side of the adhesive member in a desired design.

9. The method of claim 1, further comprising attaching an ornament to at least one of the adhesive member or the strip of material, the ornament being at least one of a button, a bead, and a jewel.

10. The method of claim 1, wherein providing an adhesive member comprises providing a substantially circular-shaped adhesive member having a diameter between about 1 inch and about 6 inches.

11. The method of claim 1, wherein providing a strip of material include providing at least one of a strip of fabric, ribbon, paper, plastic, tulle, foil, mylar, and film material.

12. A craft flower comprising:
an adhesive member, the adhesive member being substantially flat and having a first side and a second side opposite the first side, the first and second sides each having adhesive properties; and
a strip of material sufficiently manipulable so as to be gathered together, the strip of material being wrapped around and coupled to at least an outer portion of the first side of the adhesive member in a desired design.

13. The craft flower of claim 12, wherein the desired design comprises a spiral pattern that extends from one portion of the adhesive member to another portion of the adhesive member, at least a portion of the strip of material being coupled to the adhesive member, a first end of the strip of material including a knot, the knot being coupled approximately to the center of the first side of the adhesive member, the strip of material being twisted about itself.

14. The craft flower of claim 12, wherein the desired design comprises a single substantially 360-degree wrap around a portion of the adhesive member, wherein an outer side of the strip of material extends outwardly from the outer portion of the adhesive member.

15. The craft flower of claim 12, further comprising a carrier member disposed on the second side of the adhesive member.

16. The craft flower of claim 12, wherein the strip of material is at least one of a strip of flexible fabric, ribbon, paper, plastic, tulle, foil, mylar, and film material.

17. The craft flower of claim 12, further comprising an ornament coupled to the first side of the adhesive member or to the strip of material, the ornament being at least one of a button, a bead, and a jewel.

18. The craft flower of claim 12, wherein the adhesive member has a substantially circular shape, the adhesive member having a diameter between about 1 inch to about 6 inches.

19. A craft flower kit comprising:
one or more adhesive members having a substantially circular shape having a diameter between about 1 inch to about 6 inches, the one or more adhesive members each being substantially flat and having a first side bearing an adhesive and a second side opposite the first side bearing an adhesive;
a first carrier member disposed on the first side of each of the one or more adhesive members;
a second carrier member disposed on the second side of each of the one or more adhesive members; and
one or more strip of material sufficiently manipulable so as to be capable of being to be gathered together.

20. The craft flower kit of claim 19, further comprising one or more ornaments.
